(19) United States
(12) Patent Application Publication
(10) Pub. No.: US 2011/0048910 A1
(43) Pub. Date: Mar. 3, 2011

(54) Electrical Device Having A Reserve Battery Activation System

(75) Inventors: Fred Allen, Princeton Junction, NJ (US); Steve D. Simon, Middletown, NJ (US); Victor A. Lifton, Bridgewater, NJ (US); Ronald Durando, Nutley, NJ (US)

(73) Assignee: MPHASE TECHNOLOGIES, INC.

(21) Appl. No.: 12/552,736

(22) Filed: Sep. 2, 2009

(51) Int. Cl. H01H 19/14; H01H 13/00; H01H 13/14

(52) U.S. Cl. 200/336; 200/329; 200/341; 361/837

(57) ABSTRACT

An electrical device having a reserve battery activation system for efficiently activating an electrical device via a low mechanical force. The electrical device having a reserve battery activation system generally includes a housing, such as flashlight housing, FM radio housing, MP3 player housing, etc., a first actuator connected to the housing, wherein the first actuator is at least partially external to the housing, a linkage operatively connected to the first actuator, a second actuator operatively connected to the linkage opposite the first actuator, wherein the second actuator is internal to the housing and at least one reserve battery for powering at least a part of the electrical device, wherein the at least one reserve battery is internal to the housing. The reserve battery is operatively connected to the second actuator for being activated via the second actuator via applying a low mechanical force to the first actuator.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a reserve battery and more specifically it relates to an electrical device having a reserve battery activation system for efficiently activating an electrical device via a low mechanical force

2. Description of the Related Art

Any discussion of the related art throughout the specification should in no way be considered as an admission that such related art is widely known or forms part of common general knowledge in the field.

Reserve batteries and electrical devices have been in use for years. Typically reserve batteries are not incorporated within common electrical devices, such as flashlights, radios, etc. because a large mechanical force, such as through the use of explosives, hammers, etc., is commonly necessary to activate the reserve battery.

Because many electrical devices are used infrequently and many are needed or saved for emergency situations, which can occur very infrequently, standard primary batteries within the electrical devices can often times lose their charge which causes the electrical device to be unusable when needed. Because of the inherent problems with the related art, there is a need for a new and improved electrical device having a reserve battery activation system for efficiently using a reserve battery with a personal electronic device.

### BRIEF SUMMARY OF THE INVENTION

A system for efficiently using a reserve battery with a personal electronic device. The invention generally relates to an electrical device which includes a housing, such as flashlight housing, FM radio housing, MP3 player housing, etc., a first actuator connected to the housing, wherein the first actuator is at least partially external to the housing, a linkage operatively connected to the first actuator, a second actuator operatively connected to the linkage opposite the first actuator, wherein the second actuator is internal to the housing and at least one reserve battery for powering at least a part of the electrical device, wherein the at least one reserve battery is internal to the housing. The reserve battery is operatively connected to the second actuator for being activated via the second actuator via applying a low mechanical force to the first actuator.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a side view of the present invention illustrated as a flashlight.

FIG. 2 is a side view of the present invention illustrated as a flashlight and with the reserve battery being activated via a sliding motion of the first actuator.

FIG. 3 is a front view of the present invention illustrated as a radio.

FIG. 4 is a front view of the present invention illustrated as a radio and with the reserve battery being activated via a rotating motion of the first actuator.

### DETAILED DESCRIPTION OF THE INVENTION

### A. Overview

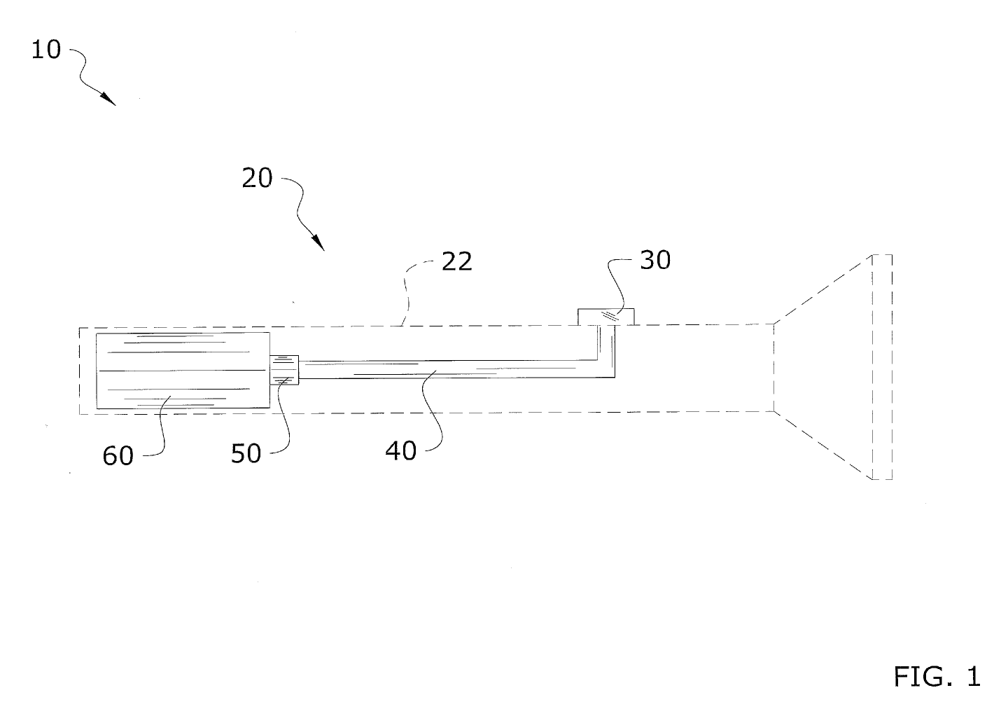

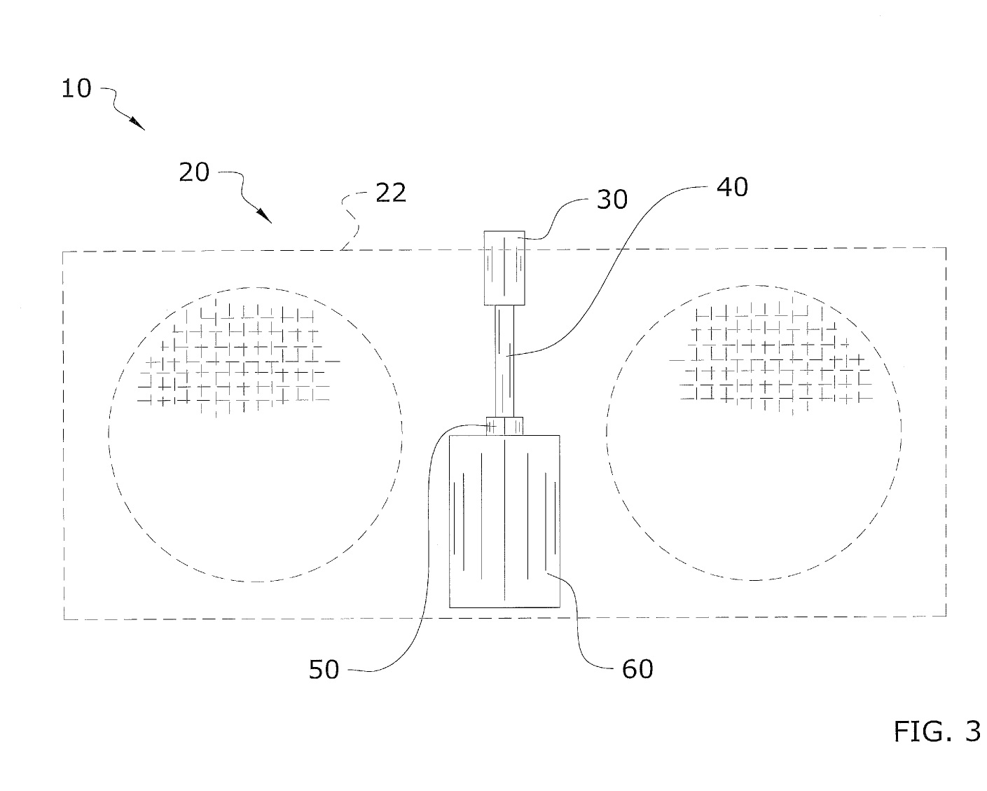

Turning now descriptively to the drawings, in which similar reference characters denote similar elements throughout the several views, FIGS. 1 through 4 illustrate an electrical device having a reserve battery activation system 10, which comprises a housing 22, such as flashlight housing, FM radio housing, MP3 player housing, etc., a first actuator 30 connected to the housing 22, wherein the first actuator 30 is at least partially external to the housing 22, a linkage 40 operatively connected to the first actuator 30, a second actuator 50 operatively connected to the linkage 40 opposite the first actuator 30, wherein the second actuator 50 is internal to the housing 22 and at least one reserve battery 60 for powering at least a part of the electrical device 20, wherein the at least one reserve battery 60 is internal to the housing 22. The reserve battery 60 is operatively connected to the second actuator 50 for being activated via the second actuator 50 via applying a low mechanical force to the first actuator 30.

### B. Electronic Device

The present invention may be used with various electronic devices 20, such as a flashlight, an FM radio, an MP3 player, or various others. The electronic device 20 may be comprised of a handheld device or a larger device. The electronic device 20 is preferably comprised of a mass produced item, such as sold as a commercial or government product.

### C. Housing

The electronic device 20 includes a housing 22 which may be comprised of various configurations, shapes, and sizes. The housing 22 may be comprised of various materials, and may be manufactured to be used in various environments. Lights, lens, etc. may be positioned on the housing 22 in the case of a flashlight configuration. Likewise, various knobs or controls may be positioned upon the housing 22 in the case of a radio structure.

### D. First Actuator

An actuator is at least partially externally located upon the housing 22 to activate the reserve battery 60 and the electronic device 20. The first actuator 30 is preferably connected to the housing 22, however it is appreciated that the first actuator 30 may be completely separate than the housing 22. The first actuator 30 is generally actuated via a low mechanical force, such as via an operator depressing, moving, twisting, rotating, pivoting, etc. the first actuator 30 through their own mechanical power and not through the assistance of powered devices 20 such as drills, explosives, etc. or large mechanical force outputting objects, such as hammers.

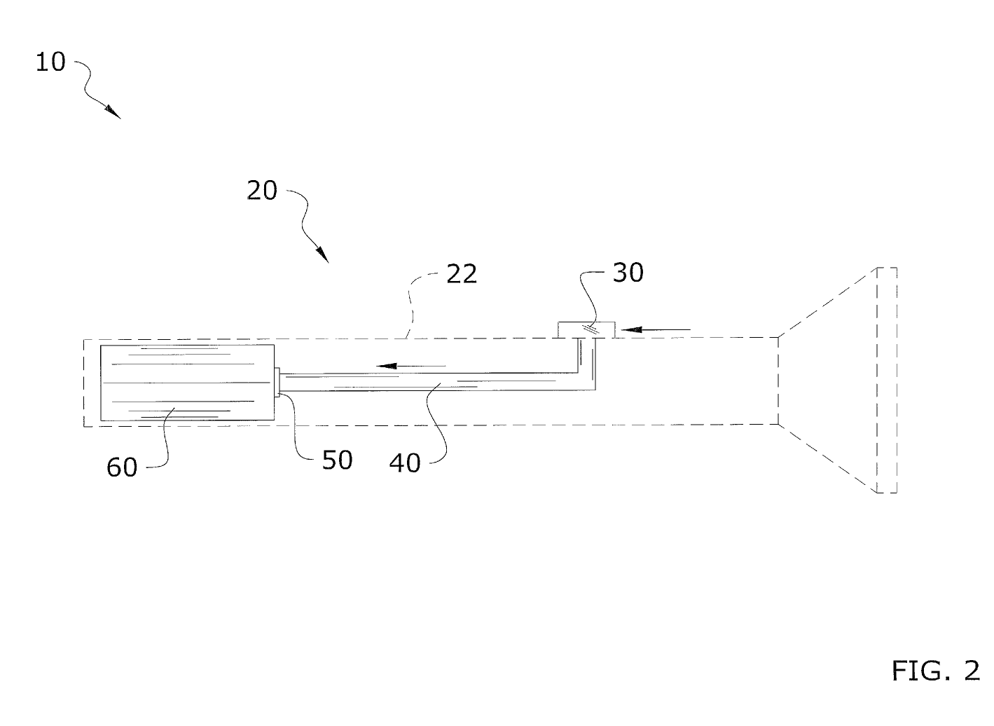

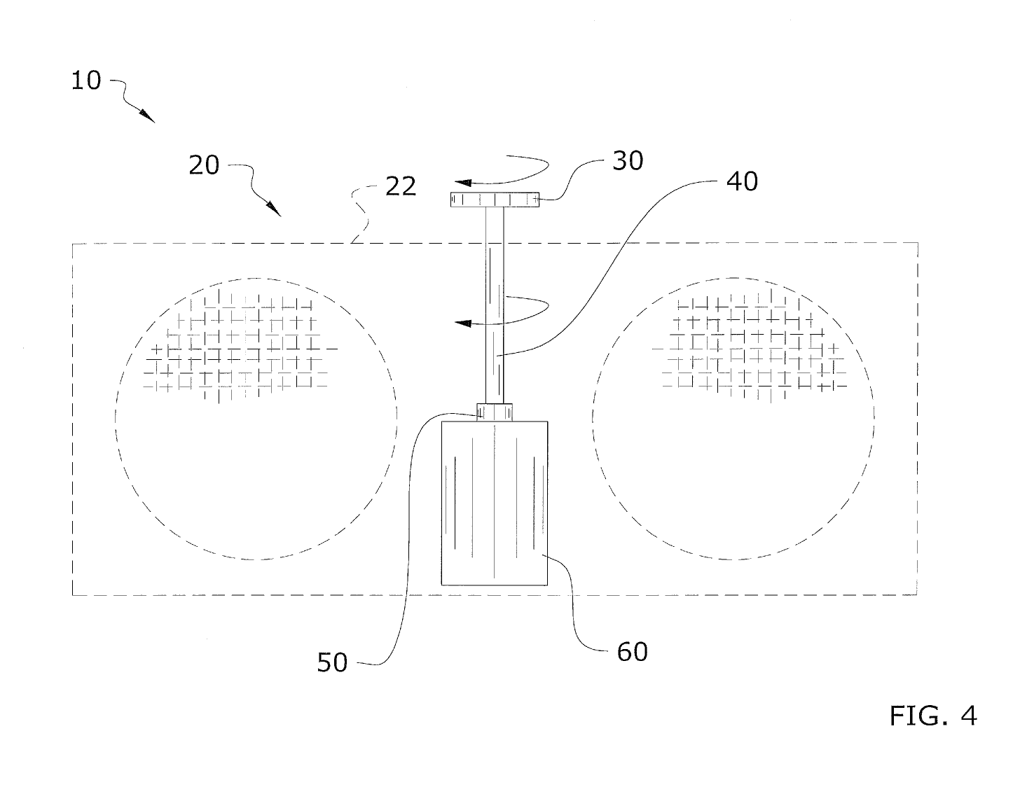

The first actuator 30 may thus be comprised of various types of buttons, controls, or switches, such as a push button, rocker switch, sliding switch, twist knob, screw, electronic control, or various other types of buttons, switches, or controls known to activate a portion or the entire electronic device 20. As described, the first actuator 30 may activate the entire electronic device 20 or simply a portion of the electronic device 20, such as turning a radio and all of its components on/off, or simply turning a light upon a radio on/off. It is appreciated that the sliding and rotatable first actuators 30 shown in FIGS. 2 and 4 may be interchanged or altered to a preferable control.

### E. Linkage

The linkage 40 is operatively connected to the first actuator 30 in a mechanical, electrical, or fluid type manner and is used to transfer energy (e.g. mechanical force, current, etc.) from the first actuator 30 to the second actuator 50 which in turn transfers the energy to the reserve battery 60 to activate the reserve battery 60. The linkage 40 is generally positioned internally of the housing 22 of the electronic device 20. The linkage 40 may transfer mechanical force from the first actuator 30, fluid force, electrical current or various other means which are capable of activating the reserve battery 60.

In one embodiment, the linkage 40 transfers an up/down movement of the first actuator 30 (such as when the first actuator 30 is comprised of a push button) via moving up/down, such as a piston movement, to activate the reserve battery 60. It is appreciated that up/down movement may imply left/right, forward/backward, or various other back and forth type movement. In another embodiment, the linkage 40 transfers a rotational movement of the first actuator 30 (such as when the first actuator 30 is comprised of a screw) via rotating, such as a screw movement, to activate the reserve battery 60. It is appreciated that the linkage 40 may be comprised of various materials or structures all which are suitable for the desired purpose of transferring the energy from the first actuator 30 to the second actuator 50 connected to the reserve battery 60.

### F. Second Actuator

The second actuator 50 is operatively connected in a mechanic, electrical, or fluidly manner to the linkage 40 within the housing 22 and also to the reserve battery 60. The second actuator 50 may be external to the reserve battery 60, internal to the reserve battery 60 or a portion of both. The second actuator 50 is generally connected to the reserve battery 60 within the housing 22 of the electrical device 20.

Once actuated by the linkage 40, the second actuator 50 breaks a barrier within the reserve battery 60 to activate the reserve battery 60 by allowing the electrolyte to mix with the electrodes and produce electrical current to be transferred to the electrical device 20. It is appreciated, that like the linkage 40 and first actuator 30, the second actuator 50 may be moved in an up/down, forward/backward, back and forth, rotatable, pivotal, or various other manners to actuate and activate the reserve battery 60.

### G. Reserve Battery

The reserve battery 60 is generally internally positioned within the housing 22 of the electrical device 20 and sufficiently powers the electrical device 20. It is appreciated that one or more reserve batteries may be used, wherein with additional reserve batteries, multiple second actuators 50 and linkages 40 may also be used to efficiently activate each of the batteries simultaneously with a single actuation (e.g. press, twist, etc.) of the first actuator 30. It is appreciated that the reserve battery 60 may be replaced or removed as desired.

The reserve battery 60 may be comprised of various conventional reserve battery 60 structures and includes an electrolyte, electrodes and at least one barrier to separate the electrolytes from the electrodes. The second actuator 50 either directly causes the barrier to break, rupture, etc. thus activating the reserve battery 60 or indirectly causes the barrier to break via another mechanism engaged by the second actuator 50. Other types of reserve batteries include those described in U.S. pending patent application “Reserve Battery” 12/499,547 filed Jul. 8, 2009. The 12/499,547 is hereby incorporated within.

### H. Operation of Preferred Embodiment

In use, to use the electronic device 20, the first actuator 30 is first actuated which causes the linkage 40 internal to the housing 22 to transfer the force put upon the first actuator 30 to the second actuator 50. Once the second actuator 50 is actuated by the linkage 40, the second actuator 50 causes the barrier of the reserve battery 60 to break thus releasing the electrolyte material of the reserve battery 60 upon the electrodes to produce electrical energy which is then transferred to the electrical device 20 through common electrical connection means (e.g. wires, etc.) to power the electrical device 20. It is stressed that only a low mechanical force need to be outputted upon the first actuator 30, such as a user simply depressing a button, flipping a switch, or rotating a knob, to actuate the first actuator 30 and start the process than eventually activates the reserve battery 60.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. An electrical device having a reserve battery activation system, comprising:
a housing;
a first actuator connected to said housing, wherein said first actuator is at least partially external to said housing;
a linkage operatively connected to said first actuator;
a second actuator operatively connected to said linkage opposite said first actuator;
wherein said second actuator is internal to said housing; and
at least one reserve battery for powering at least a part of said electrical device;
wherein said at least one reserve battery is internal to said housing;
wherein said at least one reserve battery is operatively connected to said second actuator for being activated via said second actuator via applying a low mechanical force to said first actuator.

2. The electrical device of claim 1, wherein said housing is comprised of a flashlight housing.

3. The electrical device of claim 1, wherein said housing is comprised of a radio housing.

4. The electrical device of claim 1, wherein said housing is comprised of a MP3 player housing.

5. The electrical device of claim 1, wherein said first actuator is comprised of a push button structure.

6. The electrical device of claim 5, wherein said linkage is comprised of an up/down movable structure to actuate said second actuator.

7. The electrical device of claim 1, wherein said first actuator is comprised of a rotatable structure.

8. The electrical device of claim 7, wherein said linkage is comprised of a rotatable structure to actuate said second actuator.

9. The electrical device of claim 1, wherein said linkage is internal to said housing.

10. The electrical device of claim 1, wherein said second actuator is at least partially internal to said at least one reserve battery.

11. An electrical device having a reserve battery activation system, comprising:
a housing;
a first actuator connected to said housing, wherein said first actuator is at least partially external to said housing;
wherein said first actuator is comprised of a push button structure;
a linkage operatively connected to said first actuator;
wherein said linkage is internal to said housing;
a second actuator operatively connected to said linkage opposite said first actuator;
wherein said second actuator is internal to said housing;
wherein said linkage is comprised of an up/down movable structure to actuate said second actuator in an up/down manner; and
at least one reserve battery for powering at least a part of said electrical device;
wherein said at least one reserve battery is internal to said housing;
wherein said at least one reserve battery is operatively connected to said second actuator for being activated via said second actuator via applying a low mechanical force to said first actuator.

12. The electrical device of claim 11, wherein said housing is comprised of a flashlight housing.

13. The electrical device of claim 11, wherein said housing is comprised of a radio housing.

14. The electrical device of claim 11, wherein said housing is comprised of a MP3 player housing.

15. The electrical device of claim 11, wherein said second actuator is at least partially internal to said at least one reserve battery.

16. An electrical device having a reserve battery activation system, comprising:
a housing;
a first actuator connected to said housing, wherein said first actuator is at least partially external to said housing;
wherein said first actuator is comprised of a rotatable structure;
a linkage operatively connected to said first actuator;
wherein said linkage is internal to said housing;
a second actuator operatively connected to said linkage opposite said first actuator;
wherein said second actuator is internal to said housing;
wherein said linkage is comprised of a rotatable structure to actuate said second actuator in a rotatable manner; and
at least one reserve battery for powering at least a part of said electrical device;
wherein said at least one reserve battery is internal to said housing;
wherein said at least one reserve battery is operatively connected to said second actuator for being activated via said second actuator via applying a low mechanical force to said first actuator.

17. The electrical device of claim 16, wherein said housing is comprised of a flashlight housing.

18. The electrical device of claim 16, wherein said housing is comprised of a radio housing.

19. The electrical device of claim 16, wherein said housing is comprised of a MP3 player housing.

20. The electrical device of claim 16, wherein said second actuator is at least partially internal to said at least one reserve battery.
